(19) United States
(12) Patent Application Publication
(10) Pub. No.: US 2015/0145320 A1
(43) Pub. Date: May 28, 2015

(54) METHOD OF CONNECTING NON-SYMMETRICAL INSIDE DIAMETER VEHICLE SPINDLE TO STATIONARY HOUSING AND AXLE ASSEMBLY

(71) Applicant: DANA HEAVY VEHICLE SYSTEMS GROUP, LLC, MAUMEE, OH (US)

(72) Inventors: Steven T. Byrne, Holland, OH (US); Glen D. Peterson, Sylvania, OH (US)

(73) Assignee: DANA HEAVY VEHICLE SYSTEMS GROUP, LLC, MAUMEE, OH (US)

(21) Appl. No.: 13/261,959

(22) PCT Filed: Apr. 5, 2013
(86) PCT No.: PCT/US2013/035369

§ 371 Date: Sep. 25, 2014

Related U.S. Application Data
(60) Provisional application No. 61/620,506, filed on Apr. 5, 2012.

(51) Int. Cl. B60B 35/00; B23K 20/12

(52) U.S. Cl. CPC B60B 35/004; B23K 20/129; B60B 2320/10
USPC 301/132; 29/897.2; 228/114

(57) ABSTRACT

A process for connecting a non-symmetrical inside diameter vehicle spindle to a stationary housing is provided. Low and high stress areas of the spindle are determined, where correspondingly reduced and increased material cross sections are provided or increased cross sections are located in an orientation relative to a spindle axis. Consequently, the low and high stress areas of the spindle are aligned with corresponding areas of the stationary housing. Then, the spindle and stationary housing are connected by way of friction welding. This in turn results in selecting a section modulus of the connection of the spindle to the stationary housing, thereby achieving the lowest weight to strength ratio for the connection.

### RELATED APPLICATION

This application claims the benefit under 35 U.S.C. §119(e) of U.S. Provisional Patent Application Ser. No. 61/620,506, filed Apr. 5, 2012, which is incorporated by reference herein in its entirety.

### FIELD OF THE INVENTION

The present invention relates to a method of connecting a vehicle spindle onto a stationary housing. More particularly, the present invention relates to a method of connecting a vehicle spindle having a non-symmetrical inside diameter to a stationary housing.

### BACKGROUND OF THE INVENTION

In a vehicle, a spindle is a part of an axle assembly, typically on the end of an axle, which is capable of supporting a vehicle wheel that is rotatably mounted thereon by way of a pair of axially disposed bearings. The spindle includes a cylindrical portion at its outer end which serves as an outer bearing mounting region. The portion of the spindle inboard of the outer bearing mounting region is often provided with a frusto-conical outer surface.

An inner wheel bearing has an inner race with an inner surface, which may also be frusto-conical in shape, so that the outer surface of the spindle will serve as the inner bearing mounting region.

Standard spindles are typically cold formed from hollow tubular blanks or cast as forgings, having generally uniform external diameters and wall thicknesses (see, for example, U.S. Pat. No. 4,417,462 to Palovcik). Current spindles are typically rotationally symmetrical in cross section due to limitations in the spindle attachment presented by friction welding.

What is sought is to reduce the weight of an assembly of a vehicle spindle that is connected to a stationary housing, so as to save cost for such an assembly, by possibly reducing material cross sections in low stress areas, while maintaining increased cross sections in higher stress areas. In the process of forming the assembly, it is important to result in a section modulus that selects a low weight to strength ratio of the assembly.

### SUMMARY OF THE INVENTION

A process for connecting a vehicle spindle having a non-symmetrical inside diameter to a stationary housing comprises, providing a non-symmetrical inside diameter vehicle spindle, determining high and low stress areas of the non-symmetrical inside diameter vehicle spindle, providing a) a reduced material cross section in low stress areas and an increased cross section in high stress areas or b) locating the increased cross sections in an orientation relative to the spindle axis, providing a stationary housing, aligning the low stress areas and the high stress areas of the non-symmetrical inside diameter vehicle spindle with corresponding areas of the stationary housing, and connecting the non-symmetrical inside diameter vehicle spindle to the stationary housing.

As a result, the section modulus is selectively chosen for the a) connection of the non-symmetrical inside diameter vehicle spindle to the stationary housing is provided, or b) location of the increased cross sections in an orientation relative to the spindle axis is provided, thereby achieving the lowest weight to strength ratio for the connection of the non-symmetrical inside diameter vehicle spindle to the stationary housing. Also, stiffness of the spindle is provided, which can result in lowering stress and fatigue of the spindle.

Further objects and advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a perspective view of part of one side of an vehicle axle assembly in accordance with the present invention;

FIG. 2 is a cross sectional perspective at an outboard end of the vehicle axle assembly of FIG. 1;

FIG. 3 is a cross sectional axial view of a prior art spindle; and

FIG. 4 is a cross sectional axial view of a spindle in accordance with the present invention.

### DESCRIPTION OF THE PREFERRED EMBODIMENT

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

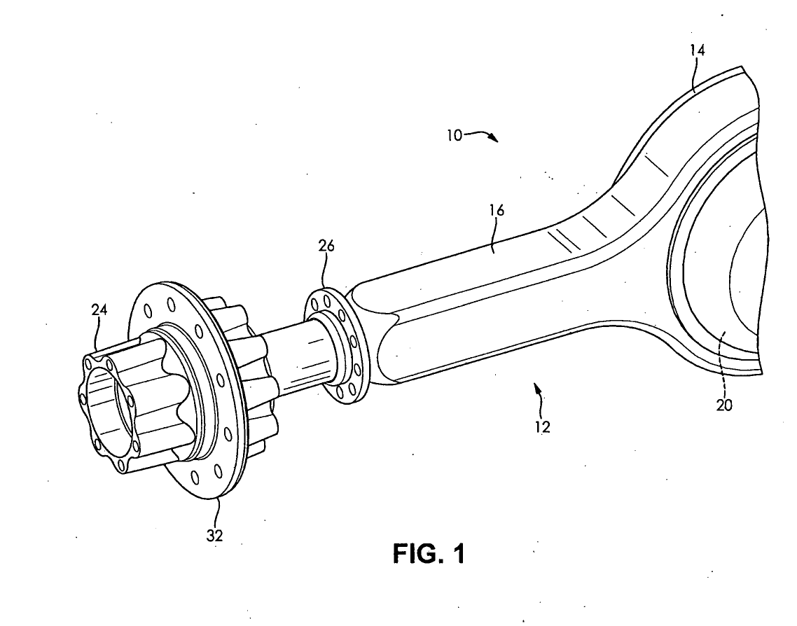

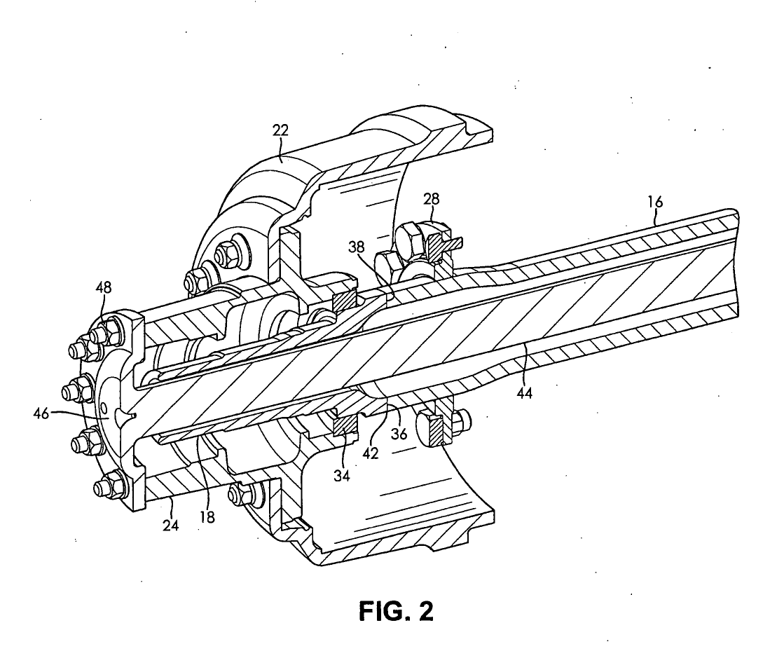

FIG. 1 illustrates part of one side of an axle assembly 10 having a stationary housing 12 that is comprised of a carrier assembly 14 and housing arm 16, with a spindle 18 (see FIG. 2) within, at an outboard end. A differential 20 (hidden) is disposed within the carrier assembly 14. The differential 20 distributes rotational mechanical power to the spindle 18 and a wheel/brake drum 22 (see FIG. 2). The spindle 18 may comprise forged steel or steel tubing.

FIG. 1 further illustrates a wheel hub 24, a brake flange 26 for mounting a brake 28 (see FIG. 2), and a wheel hub flange 32 for mounting the wheel/brake drum 22 (see FIG. 2).

The heretofore structure describes one side of the axle assembly 10, but generally applies to another side (not shown) which has a corresponding housing arm, with a spindle and wheel/brake drum that are also provided rotational mechanical power by the differential 22.

FIG. 2 illustrates a cross section of an outboard end of the partial vehicle axle assembly 10 of FIG. 1. A wheel seal 34, which blocks out dirt and debris from getting within the wheel hub 24, is shown disposed between an outside diameter (OD) on an inboard side of the spindle 18 and an inside diameter (ID) on the inboard side of the wheel hub 24.

The spindle 18 is attached, for example, by way of friction welding, on an inboard vertical surface 36 thereof to a corresponding vertical surface 38 of the housing arm 16, thereby forming an intersection 42 of the two surfaces 36, 38.

An axle shaft 44 is disposed within the housing arm 16. The inboard end of the shaft 44 is connected to the differential 20. The outboard end of the shaft 44 extends through the spindle 18. An axle shaft flange 46 is shown disposed on the outboard end of the axle shaft 44. The flange 46 is connected with mechanical fasteners 48 to the wheel hub 24, so that the rotation of the axle shaft 44 is matched to the rotation of the wheel hub 24. Not shown are various conventional bearings that facilitate the rotational motion of the spindle 18 and wheel/brake drum 22.

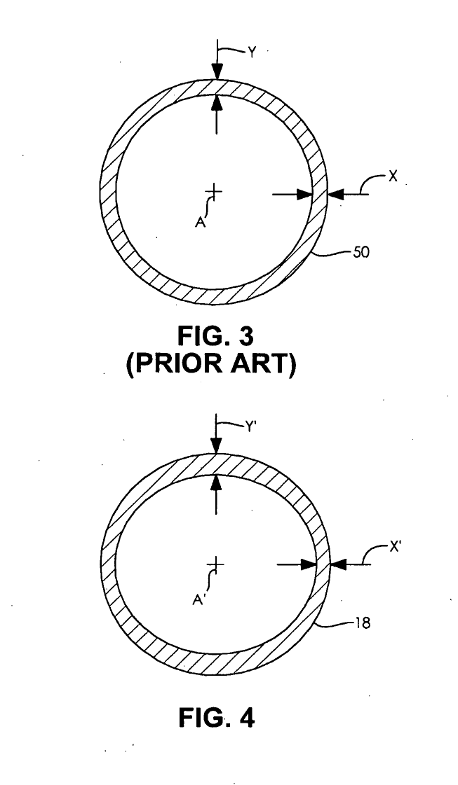

For a conventional spindle 50, an ID, which is measured in units of thickness like millimeters and fractions of an inch, is symmetrical like that shown in prior art FIG. 3, where the thickness X=Y has an axis A. In the present invention, however, an ID of the spindle 18 has a non-symmetrical configuration like that shown in FIG. 4, where the thickness X′<Y′ has an axis A′. However, the OD for the spindle 18, as shown in FIG. 4, remains constant about the axis A′.

In the present invention, high and low stress areas on the spindle 18 are determined by load conditions on a vehicle, where high load conditions exist in a vertical direction on the spindle 18. The high load conditions are caused by vertical, end, and side loading from the vehicle. Subsequently, selectivity is determined for the design calculations by applying finite element analysis (FEA) iterations to simulate the loading variation along the spindle 18.

This determining process takes into account the conflicting needs of load paths coming in from the vertical direction, fore/aft directions, the vehicle brakes, and curb loading, which leads to a non-uniform shape of the spindle that addresses all needs efficiently. The resulting stresses may not follow the shape of the spindle 18 as a clean solid of revolution, which results in a non-symmetrical spindle design. These loads that are experienced by the vehicle are taken into account to develop a non-symmetrical configuration that results in the lowest stress combined with the highest spindle stiffness.

As a result, the axle shaft 44 is oriented in the vehicle at varying pinion angles to allow for suspension set-up and travel. In other words, the orientation of the spindle 18 is adjusted during friction welding to the housing arm 16, so that high load/high stress areas along the spindle 18 line up with the increased cross sections along the axis A′ of the spindle 18. Thereby, the best orientation is provided to resist the loads from the suspension corresponding to the orientation resulting from the varying suspension angles, pinion angles, and perhaps other inputs, such as wheel track span.

During tool design, a forging die is made to provide an increased cross section/material in the higher stressed areas while the lower stressed areas are made thinner. During the forging process, the friction welders are capable of aligning the spindle in any orientation and stopping the rotation of the part where it will provide increased cross section in the area of high stress, i.e., “put in-line” with high stress areas.

As a result of the increased localized cross section, stiffness is added to that part of the spindle 18 and a section modulus is selectively chosen from a range of section moduli, which reduces the stress in the spindle 18. Subsequently, the spindle 18 is friction welded to the housing arm 16, thereby aligning the increased cross sections to the higher stressed areas. It is a discovery of the present invention that, as long as it can be forged, any uncommon shape in the hollow ID section of the spindle that can be determined by the iterative process, would be acceptable to withstand the non-uniform loads. For that matter, a thicker section may be spiral in shape, for example.

Consequently, FIG. 4 shows respective high and low stress areas for the spindle 18 having Y′=12:00 and 6:00 o'clock and X′=3:00 and 9:00 o'clock, where material was reduced, for example, by changing the profile of a punch in a reverse extrusion process for forging the spindles 18.

An equation that describes the ID and how the stress areas are determined, is from a bearing moment:

m_{BRG}=0.35(GAWR)(SLR)−0.5(GAWR)(X), where:

GAWR=Gross Axle Weight Rating in pounds;

SLR=Static Loaded Radius (of a tire) in inches; and

X=the distance from a tire centerline to a point of stress calculation.

From these factors, stress is measured as:

stress=m_{BRG}+the section modulus, which=PI*((OD̂4−ID̂4)/64)/(OD/2).

From this equation, the lowest weight to strength ratio is determined, which determines life expectancy by comparing test results to test requirements, which is then verified by fatigue life. Consequently, smooth transitioning between X′ and Y′ is achieved in the tooling/punch design.

Thus, control of the A′-axis is achieved by putting the increased cross section of the spindle 18 in-line with the high stress location. Also, the friction welding equipment is provided with the capability to stop the friction welding process by locating the high stress location in-line with the increased cross section. The above stated controls need to be in place in order to properly control the friction welder. By balancing the friction welder, the spin welding results in a better product.

Hence, the high and low stress areas of the non-symmetrical ID vehicle spindle 18 are determined, so as to provide reduced material cross section (i.e., X′) in those low stress areas and to provide increased cross section (i.e., Y′) in those high stress areas or increased cross sections, which are located in an orientation relative to a spindle axis A′. Consequently, the low and high stress areas of the spindle 18 are aligned with corresponding areas of the stationary housing 16.

This allows the spindle 18 to have a lower weight and to be less costly, while remaining functionally strong. The low and high stress areas of the spindle 18 are aligned with the corresponding areas of the stationary housing 12, so as to connect the non-symmetrical ID vehicle spindle 18 to the stationary housing 12. It has been found that the above-stated structure/process results in selecting a section modulus (from a range thereof) of the connection of the non-symmetrical ID vehicle spindle 18 to the stationary housing 12, thereby achieving the lowest weight to strength ratio for the connection of the non-symmetrical ID vehicle spindle to the stationary housing 12.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What is claimed is:

1. A process for connecting a vehicle spindle to a stationary housing, comprising:
providing a non-symmetrical inside diameter vehicle spindle comprising the steps of;
determining high and low stress areas within the non-symmetrical inside diameter of the vehicle spindle;
providing a reduced material cross section in low stress areas of the vehicle spindle and an increased material cross section in high stress areas of the vehicle spindle or providing the increased material cross sections of the vehicle spindle in an orientation relative to a spindle axis,
providing a stationary housing;
aligning the low stress areas and the high stress areas of the non-symmetrical inside diameter vehicle spindle with corresponding areas of the stationary housing;
connecting the non-symmetrical inside diameter vehicle spindle to the stationary housing; and
selecting a section modulus, from a range thereof, of the connection of the non-symmetrical inside diameter vehicle spindle to the stationary housing, thereby achieving the lowest weight to strength ratio for the connection of the non-symmetrical inside diameter vehicle spindle to the stationary housing.

2. The process of claim 1, wherein the connecting of the non-symmetrical inside diameter vehicle spindle to the stationary housing is by way of friction welding.

3. The process of claim 1, wherein the vehicle spindle comprises a steel forging.

4. The process of claim 1, wherein the vehicle spindle comprises a steel tube.

5. The process of claim 1, wherein determining stress areas comprises determining a bearing moment m_{BRG} which equals 0.35(GAWR)(SLR)−0.5(GAWR)(X).

6. The process of claim 1, further comprising determining lowest weight to strength ratio by way of finite element analysis.

7. The process of claim 1, further comprising orienting the spindle during friction welding to the housing arm, so that the high load/high stress areas along the spindle line up with the increased cross sections along the spindle.

8. The process of claim 1, wherein stiffness of the spindle is provided, resulting in lowering stress and fatigue of the spindle.

9. The process of claim 1, further comprising disposing an axle shaft within the housing arm.

10. A vehicle axle assembly, comprising:
a spindle having a non-symmetrical inside diameter, wherein reduced material cross sections of the spindle have low stress and increased material cross sections have high stress or increased cross sections being oriented, along a spindle axis;
an axle shaft rotatably connected on an inboard end to a differential and on an outboard end extended through the spindle;
a stationary housing having the spindle attached thereto, wherein the low stress areas and the high stress areas of the non-symmetrical inside diameter of the vehicle spindle are aligned with corresponding areas of the stationary housing.

11. The vehicle axle assembly of claim 10, wherein an outside diameter of the spindle is symmetrical.
